(19) United States
(12) Patent Application Publication
(10) Pub. No.: US 2016/0092773 A1
(43) Pub. Date: Mar. 31, 2016

(54) INFERENCE-BASED INDIVIDUAL PROFILE

(71) Applicant: Microsoft Corporation, Redmond, WA (US)

(72) Inventors: Margaret JoAnn Novotny, Greenbrae, CA (US); Blaise Aguera y Arcas, Seattle, WA (US); Jeffery David Howard, San Francisco, WA (US); Scott Vernon Fynn, Seattle, WA (US)

(21) Appl. No.: 14/498,935

(22) Filed: Sep. 26, 2014

(51) Int. Cl. G06N 5/04; G06N 5/02

(52) U.S. Cl. CPC G06N 5/04; G06N 5/022

(57) ABSTRACT

In many computing scenarios, individual profiles are generated from facts specified by, observed about, and/or inferred about individuals, and may be used to personalize services to such individual. Such facts may include details provoking a sensitivity of an individual, and it may be undesirable to reveal the collection and use of such facts to the individual; however, such facts may also enable accurately personalized service. These considerations may be balanced by partitioning the individual profile into a foreground profile, comprising facts that are revealed to the individual, and a background profile, comprising facts that are collected about but not revealed to the individual. Services may be covertly personalized for the individual based on the sensitive information stored in the background profile (e.g., restaurant recommendations that are overtly recommended based on the current location of the individual, and also covertly selected based on an inferred income level of the individual).

### BACKGROUND

Within the field of computing, many scenarios involve a collection of facts about an individual (e.g., directly received from the individual; observed about the individual; and/or based on an inference about the individual), where such facts are stored in an individual profile and used to personalize one or more services based on the details of the service. For example, a retail service may recommend products to an individual based on the individual's previous purchases, and a social network may present advertisements to the individual that are based on facts specified in the social profile of the individual.

Many such individual profiles may be informed by inferences about the individual, based on the contents of expressions authored by the individual and/or activities performed by the individual. For example, if an individual frequently expresses an interest in a particular type of food, or frequently visits restaurants that offer a particular type of food, an inference may be made that the individual enjoys the particular type of food, even if the individual has not expressly indicated such enjoyment in the individual profile.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Inferences about an individual may be formulated with an inference confidence that relates to the accuracy of the inference as a fact describing the individual. For example, if an individual consumes a particular type of food on a daily basis, an inference may be drawn about the individual's food preferences than if the individual only consumes the particular type of food once per month. Accordingly, the consideration of the inference confidence of the inferences while generating the individual profile through inferences (e.g., only adding inferences to the individual profile if the inference confidence in the accuracy or strength of the inference exceeds a desired threshold) may enable the formulation of a more accurate individual profile.

However, the aggregation of the individual profile based on inferences may result in a large collection of facts about the individual, which may not be significantly representative of the individual's identity. Rather, such an individual profile may include a large number of facts that, even if derived from inferences having a high inference confidence and therefore accurate about the individual, are not regarded by the individual as representing his or her particular identity. As a first such example, the individual profile may include a fact that describes the individual, but also a large number of other individuals in the individual's community, and that is therefore not distinctive of the individual; e.g., a fact that the individual enjoys ice cream may also describe everyone the individual knows enjoys ice cream, the inclusion of this fact in the individual's profile may not distinguish the individual's identity. As a second such example, the individual profile may include a fact that is only incidental to the individual's identity; e.g., the individual may visit the same restaurant every day for lunch more due to convenience than personal preference, and the individual may not consider the restaurant or food type as part of his or her identity. Indeed, the individual may not even particularly enjoy the food type at the restaurant, so even though the inference confidence in the fact that the individual frequently visits the restaurant offering the associated food type is accurate, the inferred fact that the individual enjoys the associated food type As a third such example, the individual profile may include a fact that the individual considers private; e.g., the individual may enjoy a particular music group that is associated with a negative social stigma, and may not desire this inference to be added to the individual profile.

In each of these scenarios, even if the inference exhibits a high inference confidence that the inference accurately describes the individual, the inferred fact may significantly reflect the identity of the individual. An individual profile populated with such inferred facts may therefore not adequately describe the individual.

In view of these considerations, presented herein are techniques for generating an individual profile of an individual. Upon receiving a fact about the individual at a detection time, an embodiment may determine a significance of the fact to the identity of the individual. Upon determining that the significance of the fact to the identity of the individual exceeds a significance threshold, the embodiment may add the fact to the individual profile; and upon failing to add the fact to the individual profile within an evaluation duration of the detection time, discard the fact about the individual. By evaluating the significance of each fact to the identity of the individual, and adding to the individual profile only the facts that exceed the significance threshold, the generation of the individual profile may be achieved that is more descriptive of the individual's identity than an individual profile that is simply populated with facts having a high inference confidence.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an example scenario featuring the generation of an individual profile using a set of inferences.

FIG. 2 is an illustration of an example scenario featuring the generation of an individual profile according to the significance of the respective facts to the identity of the individual, in accordance with the techniques presented herein.

FIG. 3 is a flow diagram of an example method of configuring a device to generate an individual profile in accordance with the techniques presented herein.

FIG. 4 is a component block diagram of an example system provided to configure a device to generate an individual profile in accordance with the techniques presented herein.

FIG. 5 is an illustration of an example computer-readable medium comprising processor-executable instructions configured to embody one or more of the provisions set forth herein.

FIG. 6 is an illustration of an example scenario featuring an evaluation of the significance of the fact based on the frequencies of the individual's expressions and activities in accordance with the techniques presented herein.

FIG. 7 is an illustration of an example scenario featuring an individual profile manager that evaluates the significance of the respective facts and the individual sensitivity of the individual in accordance with the techniques presented herein.

FIG. 8 is an illustration of example scenario featuring a determination of the significance of respective facts to the individual profile of the individual in accordance with the techniques presented herein.

FIG. 9 is an illustration of an example scenario featuring continued monitoring of the significance of a fact to the individual profile of an individual in accordance with the techniques presented herein.

FIG. 10 is an illustration of an example computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. Introduction

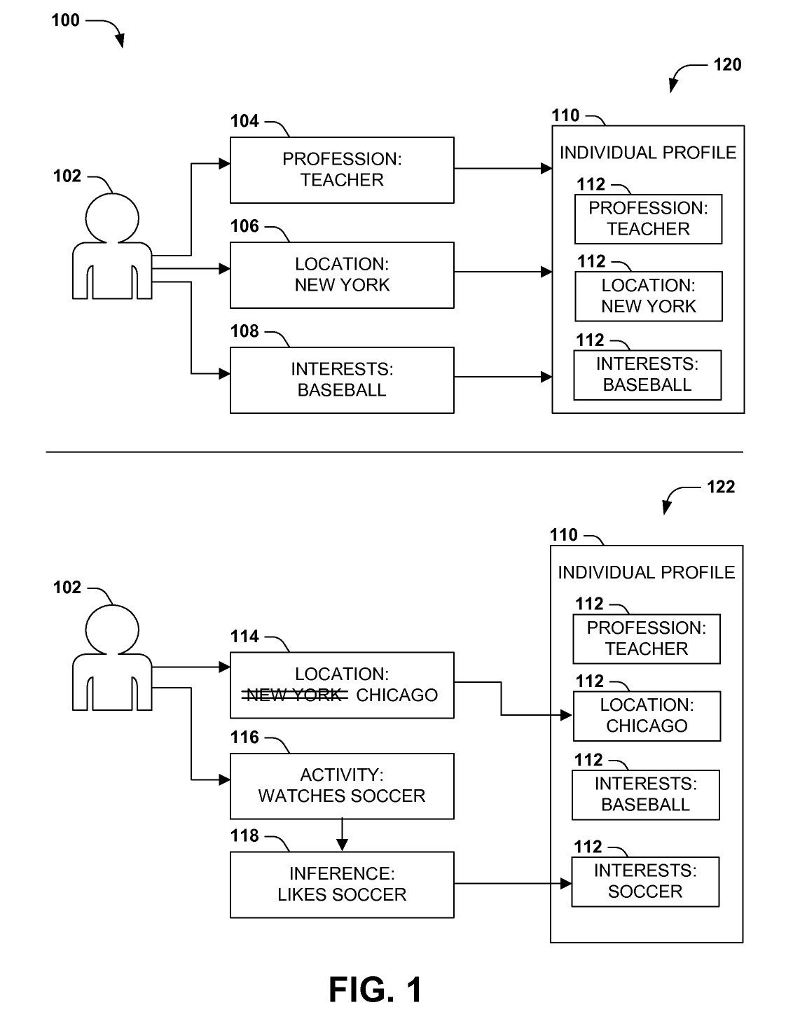

FIG. 1 presents an illustration of an example scenario 100 featuring a technique for generating an individual profile 110 of an individual 102. In this example scenario 100, at a first time 120, various inferences about the individual 102 may be formulated in order to identify facts 112 to be added to the individual profile 110. As a first such example, the individual 102 may be associated with a profession 104, such as a teacher; a location 106 where the individual 102 lives, such as New York; and an interest 108 that the individual 102 holds, such as an appreciation of the sport of baseball. Such inferences may be determined with varying degrees of inference confidence, such as the duration of the individual's tenure as a teacher; the amount of time that the individual 102 spends in New York; and the number of baseball games that the individual 102 attends. The inference confidence may be used to determine whether respective inferences accurately reflect facts 112 about the individual 102; e.g., if the individual 102 only resides in New York a few days per year, the inference confidence may be very low, but if the individual 102 resides in New York every day, the inference confidence may be very high. An embodiment may add facts 112 to the individual profile 110 only for inferences having an inference confidence that exceeds an inference confidence threshold, indicating the reliability that the associated fact 112 is true about the individual 102. Moreover, an embodiment may update the facts 112 of the individual profile as the inference confidence changes. At a second time 112, if the individual 102 updates his or her mailing address from New York to Chicago, the fact 112 in the individual profile 110 indicating the individual's location 106 may be updated. Additionally, the activities 116 in which the individual 102 frequently engages may be evaluated to adjust the inference confidence; e.g., detecting that the individual 102 is engaging in activity 116 such as watching a game of soccer may enable an inference 118 that the individual 102 harbors an interest 108 in soccer, and if the inference confidence of the inference 118 is sufficiently strong, the interest 108 may be added as a fact 112 to the individual profile 110 of the individual 102.

While inference-based techniques may be used to generate an individual profile 110 of an individual 102, such techniques based primarily upon inference confidence may result in the generation of an individual profile 110 that does not appropriately reflect the identity of the individual 102. In a variety of ways, the addition of inferences 118 to the individual profile 110 as facts 112 about the individual 102 may not reflect the traits about the individual considers significant about his or her identity.

As a first such example, an individual 102 may exhibit a profession 104 of a teacher. However, a first individual 102 consider such a profession 104 to be an integral component of his or her identity, while a second individual 102 may regard such a profession 104 only as a job or pastime. Notably, the variable attitude of such individuals 102 may be unrelated to the inference confidence that the inferences; i.e., the fact 112 that each individual 102 is a teacher may be entirely true, but may not reflect the significance of the teaching profession 104 to the identity of each individual 102. For example, both a first individual 102 and a second individual 102 may have been continuously occupied as full-time teachers for thirty years, resulting in a high inference confidence that such facts 112 are indisputably accurate; but the first individual 102 may consider the fact 112 significant to his or her identity, while the second individual 102 may not. Indeed, the second individual 102, having a thirty-year career as a teacher, may consider teaching to be less significant to his or her identity than a third individual 102 who has only been teaching for three months (and having a low inference confidence), or of a fourth individual 102 who aspires to be a teacher but has not yet been hired as such.

As a second such example, an individual 102 may reside in a particular location 114, but the individual 102 may not consider the location 114 to be particularly interesting or distinguishing of the individual 102. For example, virtually all of the individual's social connections may reside in New York, may all enjoy baseball, and may all appreciate cats. Populating the individual profile 110 of the individual 102 with these facts 112 may therefore not reflect anything distinctive or interesting about the individual 102, especially if the individual 102 anticipates sharing this individual profile 110 with the individual's social contacts who share the same traits; indeed, such facts 112 may dilute the individual profile 110 and detract from other facts 112 that the individual 102 considers representative of the individual's identity.

As a third such example, a determination that the individual 102 frequently engages in a particular activity 116 may lead to an inference 118 of a fact 112 that the individual 102 has an interest 108 in the activity 116. Even if the inference confidence is high, due to a very consistent and predictable frequency of the activity 116, in some cases, the individual 102 may not consider the interest 112 to be representative of the individual's identity. For example, the individual 102 may regularly watch soccer as a professional sports reporter, or because the individual 102 enjoys spending time with family or friends who regularly watch soccer. However, such activities 116 may be only incidental to the identity of the individual 102, and adding them to the individual profile 110 may not accurately reflect the individual's identity.

As a fourth such example, inferences 118 about the individual 102 may be achieved that identify facts 112 that the individual 102 considers to be private. Adding such facts 112 to a publicly accessible individual profile 110, even if such inferences 118 have a high inference confidence and accurately represent the individual 102, may not accurately reflect the identity that the individual 102 wishes to expose to the public.

In each such example, problems arise because even if the inference 118 about the individual 102 reflects a high inference confidence indicating that the fact 112 about the individual 102 is accurate, basing the individual profile 110 on such inferences may fail to account for whether such facts 112 are significant to the identity of the individual 102. Indeed, in many cases, inference confidence and significance may be completely unrelated (e.g., an individual's self-perception that a fact 112 representing an activity 116 significantly represents the individual's interests may be unrelated to the frequency with which the individual 102 engages in the activity 116); and in many other cases, inference confidence and significance may be inversely related. For example, an individual 102 may frequently visit a first restaurant (resulting in a high inference confidence), and may infrequently visit a second restaurant (resulting in a low inference confidence). However, the first restaurant may be an easy, nearby, or affordable option that the individual 102 chooses out of habit or convenience, and the second restaurant may be the individual's favorite restaurant that the individual 102 chooses for special occasions. Contrary to the inference confidence of each option, the individual 102 may therefore consider the “special occasion” restaurant to be highly representative of the identity of the individual 102, and may consider the convenient option not representative of the identity of the individual 102. These and other disadvantages may arise from the generation of the individual profile 110 primarily relying upon the inference confidence of inferences 118 about the individual 102.

### B. Presented Techniques

Presented herein are techniques for automatically generating an individual profile 110 of an individual 102 in view of the significance of the respective facts 112 of the individual profile 110 to the identity of the individual 102.

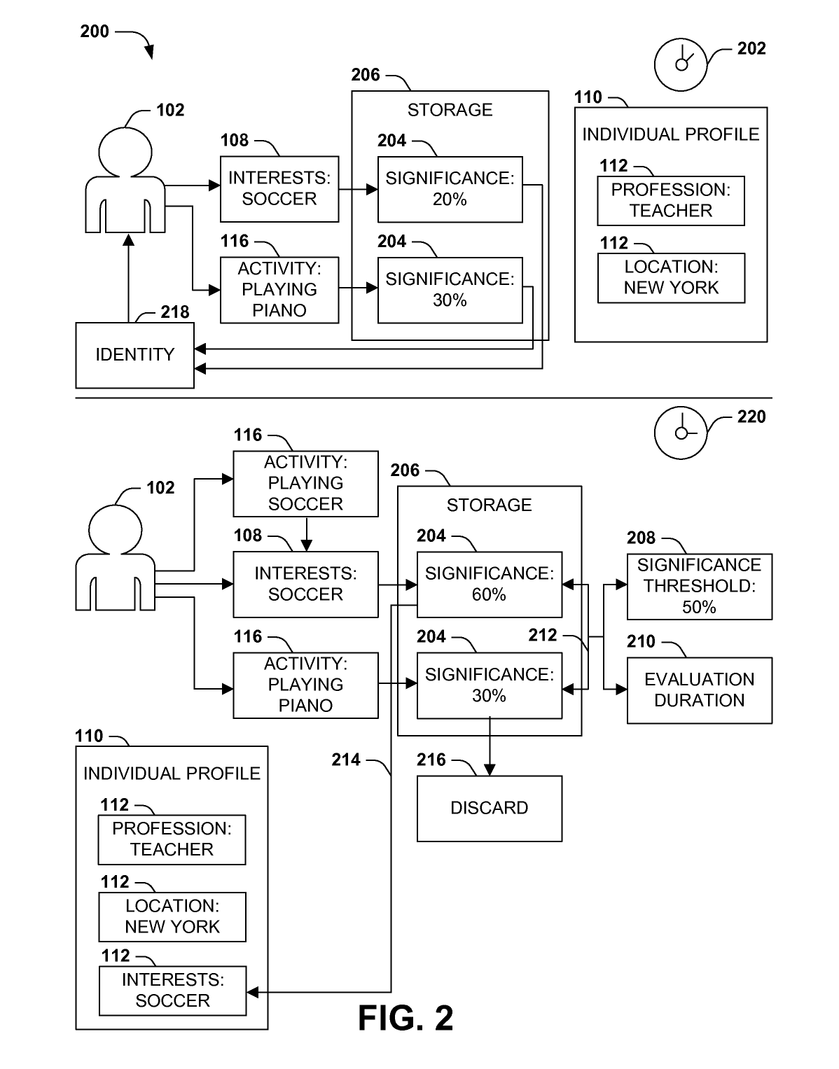

FIG. 2 presents an illustration of an example scenario 200 featuring the generation of an individual profile 110 in view of the significance 204 of the respective facts to the identity 218 of the individual 102. In this example scenario 200, at a detection time 202, the individual 102 may be represented by an individual profile 110 that already includes a few facts 112 that the individual 102 considers significant to his or her identity 218, such as the individual's location and profession. A determination may be made that the individual 102 has an interest 108 in soccer, and frequently engages in the activity 116 of playing the piano. However, an initial determination may be made of the significance 204 of each fact 112 to the identity 218 of the individual 102. Because the initial determination of the significance 204 of each fact 112 is not above a significance threshold 208, the facts 112 corresponding to the interest 108 and activity 116 are stored in storage 206 rather than in the individual profile 110. The significance 204 of each fact 112 in storage 206 is the monitored (e.g., by comparing the respective facts 112 with additional expressions and activities 116 of the individual 102). At a second time 220, when the individual 102 is further detected to engage in the activity 116 of playing soccer, the significance 204 of the interest 108 to the identity 218 of the individual 102 in the sport of soccer is determined to have exceeded the significance threshold 208, and the fact 112 is moved from storage 206 to the individual profile 110. Alternatively, at the second time 220, the activity 116 of playing piano has not achieved a significance 204 to the identity 218 of the individual 102 that exceeds the significance threshold 208 within an evaluation duration 210 of the detection time 202 (e.g., the evaluation of the significance 204 of the piano-playing activity 116 has been evaluated for three days since the first instance of the activity 116, and the individual 102 has not exhibited any further signs of interest in the activity 116). Rather than adding the activity 116 as a fact 112 to the individual profile 110, a device may instead discard 216 the fact 112 corresponding to the activity 116 from storage 206. In this manner, the individual profile 110 of the individual 102 is generated based on the evaluation of the significance 204 of respective facts 112 to the identity 218 of the individual 102 in accordance with the techniques presented herein.

### C. Technical Effects

The use of the techniques presented herein to generate an individual profile 110 may result in a variety of technical effects.

As a first example of a technical effect that may be achievable by the techniques presented herein, the generation of the individual profile 110 based on the significance 204 of the facts 112 to the identity 218 of the individual 102 may enable the generation of an individual profile 110 that more accurately represents the identity 218 of the individual 102. That is, the individual profile 110 is not diluted with facts 112 that are accurate but only incidental to the identity 218 of the individual 102; with facts 112 that are true of a large number of individuals 102, and that therefore do not particularly distinguish the individual 102; and with facts 112 that are representative of the individual frequently performs out of habit, convenience, or obligation, but that are representative of the individual's choices. Limiting the facts 112 included in the individual profile 110 to those that have significance 204 to the identity 218 of the individual 102 may therefore provide a more concise individual profile 110 that more accurately reflects the identity 218 of the individual 102. For example, if a first individual 102 requests to view the individual profile 110 of a second individual 102, a device may respond by enumerating a small set of facts 112 that provide an insightful representation of the identity 218 of the second individual 102, rather than a laundry list of facts 112 that may be accurate about the second individual 102 but may not reflect the identity 218 of the second individual 102.

As a second example of a technical effect that may be achievable by the techniques presented herein, providing an automated evaluation of respective facts 112, and an automated determination of the significance 204 of respective facts 112 to the identity 218 of the individual 102, may reduce the interaction of the individual 102 to generate and maintain the individual profile 110. For example, a device may generate an individual profile 110 comprising every possible fact 112 about a particular individual 102, and may request or allow the individual 112 to choose and arrange the facts 112 according to their significance 204 to the identity 218 of the individual 112. However, such manually curated individual profiles 110 may be frustrating for the individual 102, and if the individual 102 does not regularly perform such manual curation, the facts 112 of the individual profile 110 may steadily diverge from the identity 218 of the individual 102 (e.g., facts 112 may become out of date, and new facts 112 may fail to be added). By contrast, the techniques presented herein enable an automated determination of the significance 204 of the facts 112 to the identity 218 of the individual 102, and may therefore reduce the dependency on the manual curation of the individual profile 110 by the individual 102.

As a third example of a technical effect that may be achievable by the techniques presented herein, the representation of a set of individuals 102 based on individual profiles 110 that are limited to facts 112 that have significance 204 to the identity 218 of the individual 102 may inform searches applied to the set of individuals 102. For example, if an individual 102 searches among a social network for other individuals 102 who live in New York (e.g., for a recommendation of tourist destinations), it may not be helpful to provide a set of search results comprising every individual 102 whose individual profile 110 includes the fact 112 that the individual 102 resides or once resided in New York, as some individuals 102 may live in New York but may not be particularly interested in it; other individuals 102 may only occasionally live in New York; and still other individuals 102 may have previously lived in New York, but may no longer consider it a part of their identity 218. Finding an individual 102 among such an individual set who is capable of and interested in presenting recommendations of New York tourist destinations may therefore be difficult. Conversely, limiting the search results to the individuals 102 for whom New York has a significance 204 to their identity 218, including those who reside in New York and take an active interest in it, as well as those who have visited New York only occasionally but place great personal interest in such visits, may yield search results that are more suitable to the provided query.

As a fourth example of a technical effect that may be achievable by the techniques presented herein, limiting the individual profiles 110 of a set of individuals 102 to facts 112 that are associated with the significance 204 of the individual 102 may promote the scalability of services and processes that depend on such individual profiles 110. For example, maintaining an exhaustive list of every fact 112 that may accurately describe each of many thousands of individuals 102 may involve significantly greater data storage, processing, and communication capabilities than limiting each individual profile 110 to a smaller set of facts 112 that have a significance 204 to the identity 218 of each individual 102.

As a fifth example of a technical effect that may be achievable by the techniques presented herein, limiting the individual profiles 110 may enable a more thorough evaluation and monitoring of the significance 204 of such facts 112 to the identity 218 of the individual 102. For example, attempting to monitor hundreds of facts 112 that might describe an individual 102 to maintain an updated inference confidence, e.g., every activity 116 that the individual 102 has performed at least once, and every restaurant that the individual 102 has visited at least once, may entail a significant expenditure of computational resources of the devices of the individual 102, and may even scale to an unfeasible level of evaluation over many years of fact-gathering (e.g., the fact that the individual 102 watched a soccer game six years ago may not warrant a continued exploration of whether the sport of soccer is to be included in the individual profile 110 of the individual 102). Conversely, by limiting such evaluation to the facts 112 of the individual profile 110 that have previously been determined to have a significance 204 exceeding a significance threshold 208, and to facts 112 that have recently been detected and are kept in storage 206 only briefly for the evaluation duration 210, a device may apply a more thorough monitoring of the limited set of facts 112 that may result in a more accurate determination. Similarly, discarding 216 facts 112 that do not achieve a significance 204 above the significance threshold 208 within the evaluation duration 210 may enable a more rigorous significance evaluation of the smaller set of facts 112 that are currently kept in storage 206. These and other technical effects may be achievable through the application of the techniques presented herein.

### D. Example Embodiments

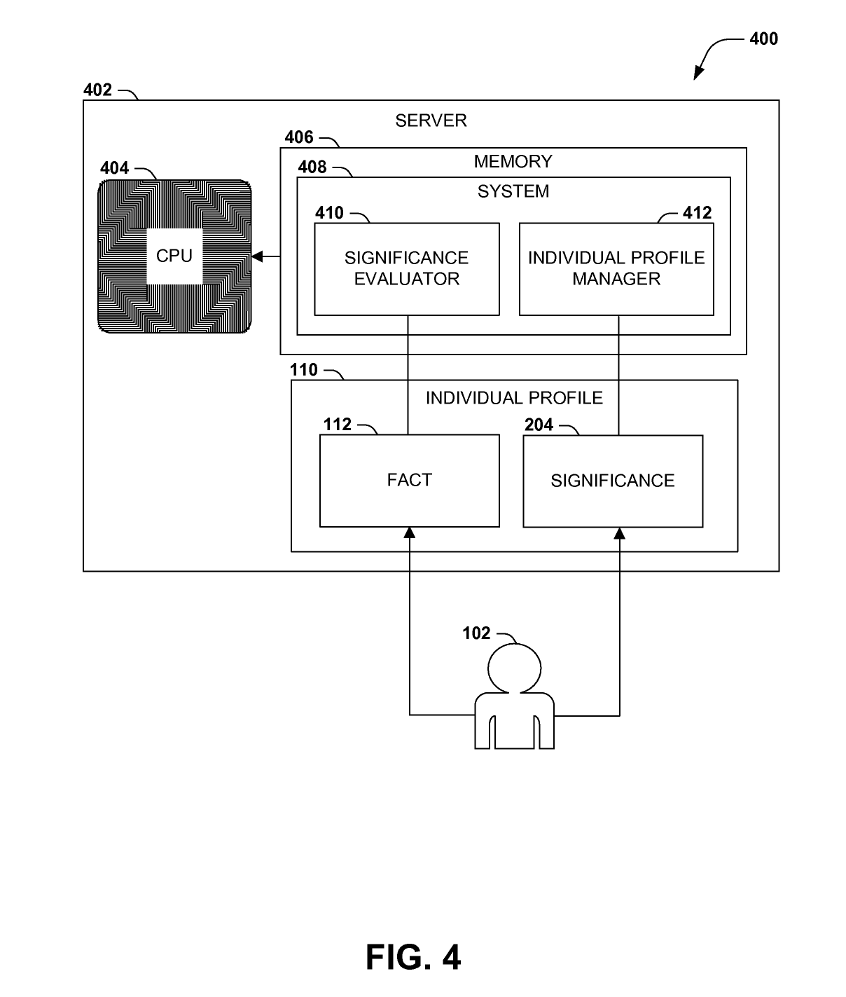

FIG. 4 presents a first example embodiment of the techniques presented herein, illustrated as an example method 300 of representing an individual profile 110 of an individual 102. The example method 300 may be implemented, e.g., as a set of instructions stored in a memory component of a device, such as a memory circuit, a platter of a hard disk drive, a solid-state storage device, or a magnetic or optical disc, and organized such that, when executed on a processor of the device, cause the device to operate according to the techniques presented herein.

The example method 300 begins at 302 and involves executing 304 the instructions on a processor of the device. Specifically, executing 304 the instructions on the processor causes the device to, upon receiving 306 a fact 112 about the individual 102 at a detection time 202, determine 308 a significance 204 of the fact 112 to the identity 218 of the individual 102. Executing 304 the instructions may further cause the device to, upon determining that the significance 204 of the fact 112 to the identity 218 of the individual 102 exceeds a significance threshold 208, add 310 the fact 112 to the individual profile 110. Executing 304 the instructions may further cause the device to, upon failing to add the fact 112 to the individual profile 110 within an evaluation duration 210 of the detection time 202, discard 312 the fact 112 about the individual 102. In this manner, the instructions cause the device to represent the individual 102 with an individual profile 202 according to the techniques presented herein, and so ends at 314.

FIG. 4 presents a second example embodiment of the techniques presented herein, illustrated as an example server 402 featuring a processor 404 and a memory 406 storing an example system 408 that causes the server 402 to generate an individual profile 110 of an individual 102. The example system 408 may be implemented, e.g., as a set of components respectively comprising a set of instructions stored in the memory 406 of the server 402, where the instructions of respective components, when executed on the processor 404, cause the server 402 to operate in accordance with the techniques presented herein.

The example system 408 includes a significance evaluator 410 that determines a significance 204 of a fact 112 to the identity 218 of the individual 102. The example system 408 also includes an individual profile manager 412 that, upon the significance evaluator 410 determining that the significance 204 of the fact 112 to the identity 218 of the individual 102 exceeds a significance threshold 208, adds the fact 112 to the individual profile 110; and, upon failing to add the fact 112 to the individual profile 110 within an evaluation duration 210 of the detection time 202, discards 216 the fact 112 about the individual 102. In this manner, the example system 408 enables the server 402 to generate the individual profile 110 in accordance with the techniques presented herein.

Still another embodiment involves a computer-readable medium comprising processor-executable instructions configured to apply the techniques presented herein. Such computer-readable media may include various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein. Such computer-readable media may also include (as a class of technologies that excludes communications media) computer-computer-readable memory devices, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein.

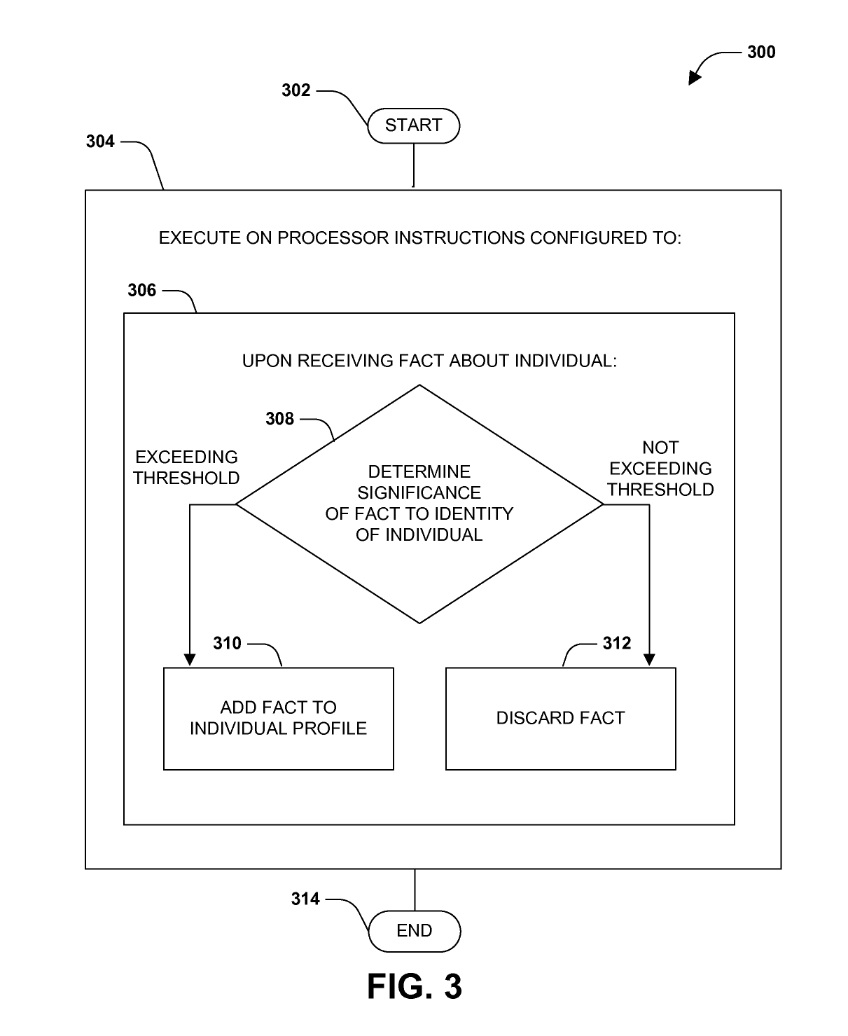

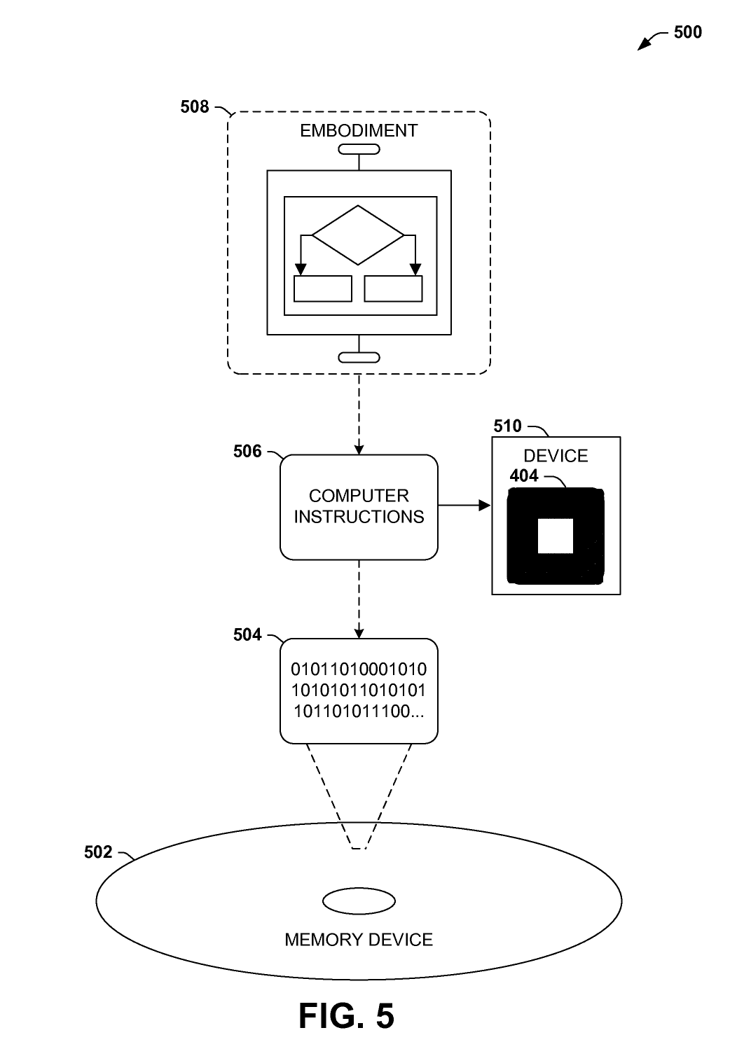

An example computer-readable medium that may be devised in these ways is illustrated in FIG. 5, wherein the implementation 500 comprises a computer-readable memory device 502 (e.g., a CD-R, DVD-R, or a platter of a hard disk drive), on which is encoded computer-readable data 504. This computer-readable data 504 in turn comprises a set of computer instructions 506 configured to operate according to the principles set forth herein. In one such embodiment, the processor-executable instructions 506 may be configured to perform a method 608 of generating an individual profile 110 of an individual 102, such as the example method 300 of FIG. 3. In another such embodiment, the processor-executable instructions 506 may be configured to implement a system for generating an individual profile 110 of an individual 102, such as the example system 408 of FIG. 4. Many such computer-readable media may be devised by those of ordinary skill in the art that are configured to operate in accordance with the techniques presented herein.

### E. Variations

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the example method 300 of FIG. 3; the example system 408 of FIG. 4; and the example memory device 502 of FIG. 5) to confer individual and/or synergistic advantages upon such embodiments.

### E1. Scenarios

A first aspect that may vary among embodiments of these techniques relates to the scenarios wherein such techniques may be utilized.

As a first variation of this first aspect, the techniques presented herein may be utilized to achieve the configuration of a variety of devices, such as workstations, servers, laptops, tablets, mobile phones, game consoles, portable gaming devices, portable or non-portable media players, media display devices such as televisions, appliances, home automation devices, and supervisory control and data acquisition (SCADA) devices.

As a second variation of this first aspect, the techniques presented herein may be utilized to partition and use various types of individual profiles 11-, including social networking and social media profiles; academic and/or professional individual profiles; gaming profiles provided for a gaming service; media profiles for individuals 102 producing and/or consuming various types of media; individual behavior profiles of devices that monitor the behavior of the individual 102; governmental profiles of the civic details of various individuals 102; financial profiles of the financial status of various individuals 102; and commercial profiles of the savings and/or purchasing behaviors of various individuals 102.

As a third variation of this first aspect, the techniques presented herein may involve the evaluation of many types of facts 112 that may describe the individual 102, including those specified directly by the individual 102; those specified by a first individual 102 about a second individual, such as a referral service; those detected about the individual 102, such as a device that monitors one or more activities 116 of the individual 102 (e.g., a global positioning system that tracks the movement of the individual 102); and inferences 118 about the individual 102 (e.g., behavioral or personality traits about the individual 102 based on statistical and/or demographic factors, such as an inferred income level of an individual 102 based on the average income in a neighborhood including the personal residence of the individual 102).

As a fourth variation of this first aspect, the individual profile 110 may be used to provide various types of services on behalf of the individual 102, such as a commercial service; a product, media, or service recommendation service; a social network or referral service; a matchmaking service, such as a dating service or a multiplayer game matchmaking service; an employment service; an information delivery service; and an advising service, such as a financial or career advising service. Many such scenarios may provide a context for utilizing the techniques presented herein.

### E2. Significance Determination

A second aspect that may vary among embodiments of the presented techniques involves the manner of determining the significance 204 of a fact 112 to the identity 218 of the individual 102, and may utilize various sources of information to determine the significance 204 of the fact 112 to the identity 218 of the individual 102.

As a first variation of this second aspect, an embodiment may determine the significance 204 of the fact 112 by detecting, among an expression set of expressions by the individual 102, an expression of whether the fact 112 has significance 204 to the individual 102. As a first such example, the individual 102 may expressly indicate that a fact 112 is significant to the identity 218 of the individual 102 (e.g., “I love golfing!”), or may indicate that a fact 112 is not significant to the identity 218 of the individual 102 (e.g., “I don't really like pizza”). As a second such example, the individual 102 may indicate the significance 204 of facts 112 while manually curating the individual profile 110; e.g., when the individual 102 adds, approves, and/or highlights a fact 112 in the individual profile 110, the fact 112 may be construed as having significance 204 to the identity 218 of the individual 102; whereas if the individual 102 removes, disapproves, and/or downplays a fact 112 in the individual profile 110, the fact 112 may be construed as not having significance 204 to the identity 218 of the individual 102. In one such embodiment, the individual 102 may specify a fact order of the respective facts 112 of the individual profile 110, wherein a first fact 112 having an earlier fact order in the individual profile is more significant than a second fact 112 having a later fact order in the individual profile; and the fact order of each fact 112 may be construed as relating to the significance 204 of the fact 112 to the identity 218 of the individual 102.

As a second variation of this second aspect, an embodiment may determine the significance 204 of the fact 112 by detecting, among an expression set of expressions by the individual, a frequency of references to the fact 112 by the individual 102. For example, a fact 112 may be more likely to be related to the identity 218 of an individual 102 who frequently refers to and/or spontaneously raises the fact 112 in conversations, status messages, or content items such as written articles, or who generates sound, images, or video recordings that are related to the fact 112, than an individual 102 who seldom refers to and/or spontaneously raises the fact 112.

As a third variation of this second aspect, the significance 204 of the fact 112 to the identity 218 of the individual 102 may be determined by detecting activities according to the activity conformity of the activities 116 performed by the individual 102. For example, for the respective activities 116 performed by the individual 102, an embodiment may determine whether the activity 116 conforms with the fact 116, and the significance 204 may be determined proportionally with the activity conformity frequency of the conforming activities 116. As a further variation, the activities 116 so assessed may be distinguished between activities 116 that the individual 102 performs out of significant choices, and the activities 116 that the individual 102 performs out of obligation, habit, or convenience. That is, the determination of significance 204 may focus on the activities 116 that the individual 102 chooses when presented with a selection of viable options, and may factor out the activities 116 for which the individual 102 does not have a choice (e.g., forgoing an opportunity to watch a soccer game due to a conflicting school or work obligation may not be construed as diminishing the significance 204 of the interest 108 of the individual 102 in the sport of soccer).

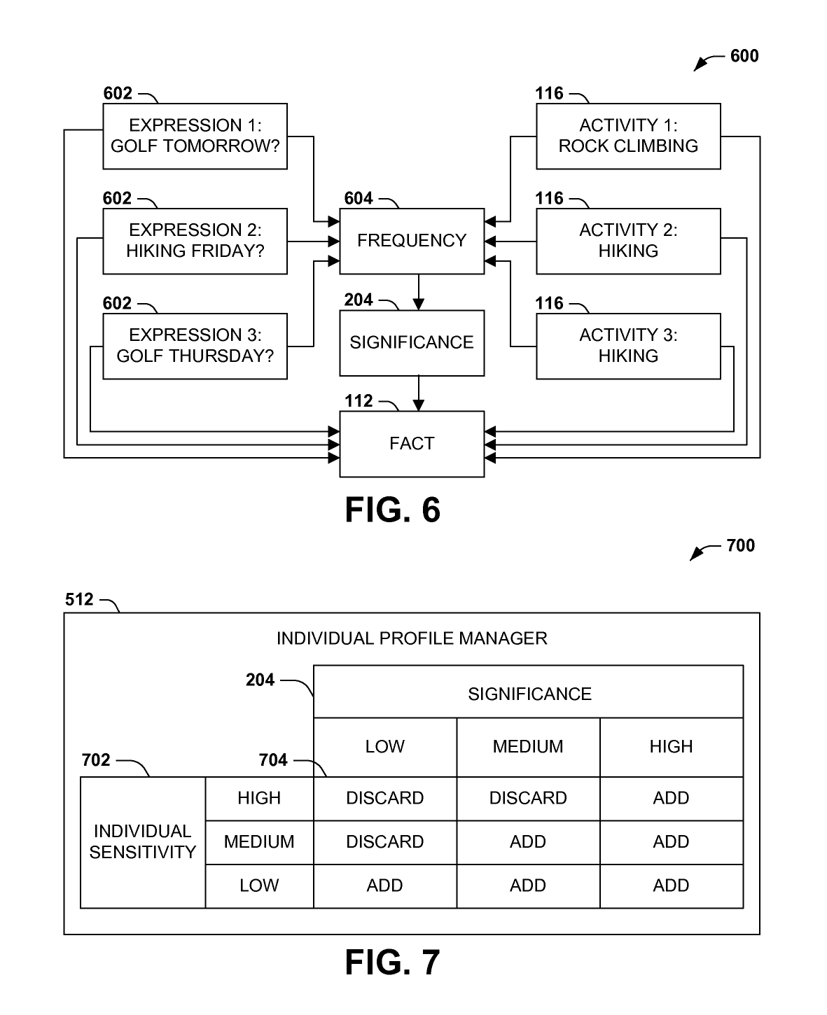

FIG. 6 presents an illustration of an example scenario 600 featuring the determination of the significance 204 of various facts 112 to the identity 218 of an individual 102. In this example scenario 600, the facts 112 relates to the interest of the individual 102 in various activities 116, such as golfing, hiking, and rock climbing. An embodiment may detect that among the expressions 602 of the individual 102 (e.g., messages exchanged with the individual's acquaintances in a social network), the individual 102 references golfing with a high frequency 604, references golfing with a lower frequency 604, and never references rock climbing. The embodiment may also detect that, when presented with opportunities to perform activities 116, the individual 102 frequently chooses hiking 116, but never chooses golfing, and instead chooses opportunities to engage in other activities 116 over the activity 116 of golfing. An embodiment may interpret such frequencies 604 in a variety of ways. With respect to hiking, since the individual both references hiking in expressions 602 and performs activities 116 that conform with the fact 112, the fact 112 of an interest 108 in hiking may be determined to have a high significance 204 to the identity 218 of the individual. However, with respect to rock climbing and golfing, an embodiment may determine that the discrepancy between the frequency 604 of references to the fact 112 in the expressions of the individual 102 and the frequency 604 of the activity conformity of the activities 116 with the fact 112 may indicate that the fact 112 does not have high significance 204 to the individual 102. An embodiment may further evaluate whether such discrepancy is due to a low significance 204 of the fact 112 to the individual 102 (e.g., the individual frequently discusses golfing as a business development opportunity, but does not choose to participate in golfing because the individual does not actually like golfing) or whether the discrepancy is due to limitations that are not related to the significance 204 of the fact 112 (e.g., whether the individual would engage in golfing 602 more frequently, but is unable to do so because of an injury or the unavailability of nearby golf courses).

When presented with conflicting information about the significance 204 of a fact 112, embodiments may utilize a variety of techniques to identify the significance 204 of the fact 112 to the identity 218 of the individual 102. In particular, techniques involving learning algorithms may be well-suited for reconciling such conflicting information. As one example, an artificial neural network may be trained to determine the significance 204 of a fact 112 using a training data set that identifies, for a set of facts 112 pertaining to a set of individuals 102, the frequencies 604 of expressions 602 and activities 116 performed by the individuals 102, and the significance 204 of the facts 112 to the identity 218 of each individual 102 as self-reported by the individuals 102. Such self-identification may enable the learning network to assess which qualities reflect the significance 204 of each fact 112 to the identity 218 of an individual 102. For example, a first fact 112 that represents an interest 108 in a “spectator sport,” such as professional football, may be readily determined by the frequency 604 of expressions 602, and less proportional with the performance of related activities 116 such as actually playing football; whereas a second fact 112 that involves interests 108 that are performance-based, such as yoga, may be more readily assessed by the frequency 604 of the individual's performance of the activity 116 than by the frequency 604 with which the individual 102 references the activity 116 in expressions 602. A learning algorithm, such as an artificial neural network, may be able to determine the factors about a fact 112 that most consistently relate to the self-reported significance 204 of the fact 112 to the identity 218 of the individual 102, and once trained using a training data set, may be applied to the expressions 602 and activities 116 of individuals 102 to determine the significance 204 of such facts 112 to the identities thereof, in accordance with the techniques presented herein.

### E3. Supplemental Information

A third aspect that may vary among embodiments of the techniques presented herein relates to the use of supplemental information that, together with the determination of the significance 204 of a fact 112 to the identity 218 of an individual 102, enables a determination of whether to add the fact 112 to the individual profile 110 of the individual 102.

As a first variation of this third aspect, the significance 204 of the fact 112 to the identity 218 of the individual 102 may involve a consideration of the sensitivity of the fact 112 to the individual 102. In some scenarios, a fact 112 may be accurate and even significant to the individual 102, but may also be considered by the individual 102 to be private and/or sensitive, and therefore not having significance 204 to the public identity 218 of the individual 102. Accordingly, an embodiment may predict the sensitivity of the individual to acknowledging a fact 112, and may discard facts 112 where the predicted sensitivity of the individual 102 exceeds a sensitivity threshold. Such prediction may be based on particular facts 112 (e.g., determining that a particular fact 112 is generally regarded as a “guilty pleasure,” such as an interest 108 in an unpopular musical group), and may evaluate the fact 112 as having low significance 204 to the identity 218 of the individual 102 unless the individual 102 expressly acknowledges the fact 112. Alternatively or additionally, the sensitivity of individuals 102 may be determined on a cultural basis. For example, a fact 112 may be considered sensitive to individuals 102 of a first demographic, but not sensitive to individuals 102 of a second demographic (e.g., individuals 102 of a first age range may openly appreciate a particular television show, but individuals 102 of a second age range who appreciate the same television show may be reluctant to admit such interest 108). Accordingly, the significance 204 of a fact 112 to the identity 218 of an individual 102 may be predicted by determining a demographic trait of the individual 102, and determining a demographic sensitivity to the fact 112 among an individual set of individuals 102 that exhibit the demographic trait.

FIG. 7 presents an illustration of an example scenario 700 wherein the individual sensitivity 702 of the individual is taken into consideration while determining whether to add a fact 112 to the individual profile 110 of an individual 102. In this example scenario 700, a fact 112 is evaluated as having either a high, medium, or low significance 204 to the identity 218 of an individual 102. Additionally, the individual 102 is predicted as having either high, medium, or low individual sensitivity 702 to acknowledging the fact 112 as significant to the identity 218 of the individual 102. Accordingly, an embodiment (such as an individual profile manager 512) may take into consideration both the significance 204 and the individual sensitivity 702 of the fact 112 to the identity 218 of the individual 102, and may therefore determine 704 whether to discard the fact 112 or add the fact 112 to the individual profile 110 of the individual 102.

As a second variation of this third aspect, in addition to considering the significance 204 of a fact 112 to the identity 218 of an individual, an embodiment may take into consideration the inference confidence of an inference 118 upon which the fact 112 is based. Contrasting with the example scenario 100 of FIG. 1 in which the inference confidence of the inference 118 is the primary determinant of adding the fact 112 to the individual profile 110, in this third variation, the inference confidence of the inference 118 may be considered together with the significance 204 of the resulting fact 112 to the identity 218 of the individual 102.

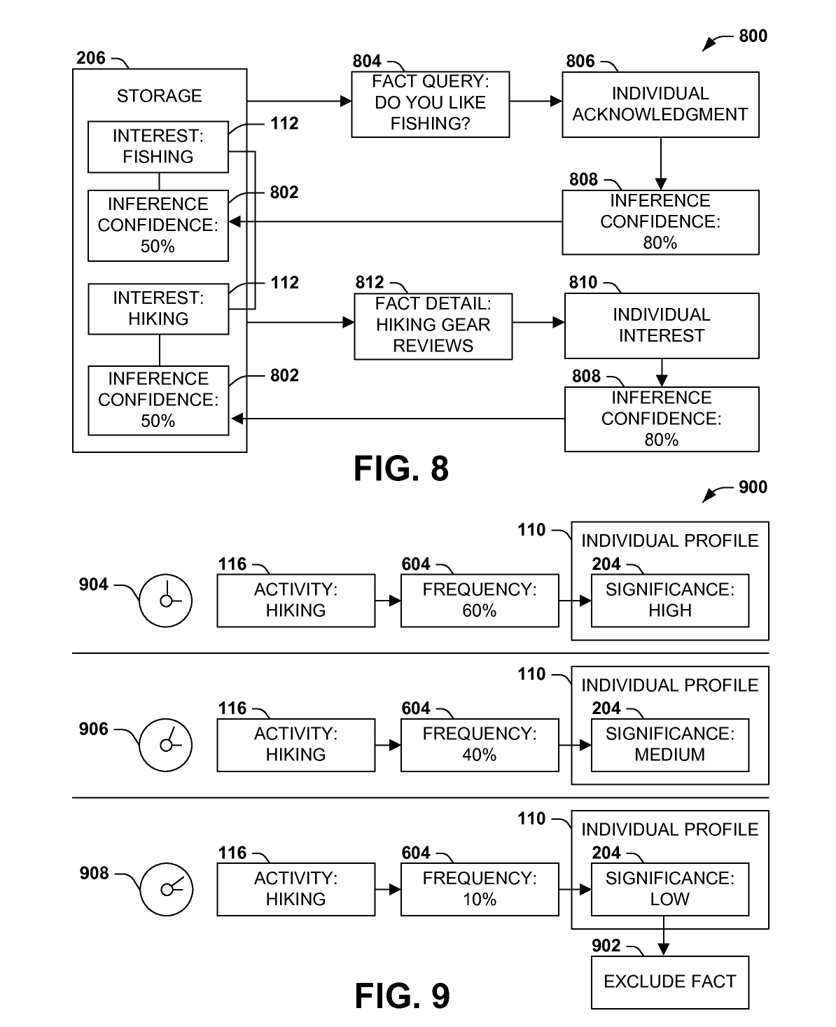

FIG. 8 presents an illustration of an example scenario 800 featuring a first technique for determining an inference confidence 802 indicating whether an inference 118 accurately reflects a fact 112 about an individual 102. In this example scenario 800, a first fact 112 kept in storage 206 (and not yet included in the individual profile 110) reflects an interest 108 of the individual 102 in a particular activity 116, such as fishing. However, an inference confidence 802 of the inference 118 may be comparatively low, e.g., only 50% confidence that the fact 112 is accurate about the individual 102. Because such an inference confidence 802 may be “borderline,” i.e., not sufficient either to add the fact 112 to the individual profile 110 or to discard the fact 112, an embodiment may directly query the individual 102 about his or her interest 108 in the activity 116, e.g., presenting a fact query 804 such as “do you like fishing?” A detection of an individual acknowledgment 810 of the fact 804 may enable an adjustment 808 of the inference confidence 802 that, in addition to the determination of the significance 204 of the fact 112 to the identity 218 of the individual 102, enables a determination of whether to add the fact 112 to the individual profile 110 or to discard the fact 112. As a second such example, rather than directly querying the individual 102, an embodiment may subtly prompt the individual 102 for an expression of individual interest 810. For example, an embodiment may present to the individual 102 a fact detail 812 about the fact 112 (e.g., a link to reviews of hiking gear), and may detect whether or not the individual 102 exhibits individual interest 810 in the fact detail 812. A detection of individual interest 810 in the fact detail 812 may enable an adjustment 808 of the inference confidence 802 that, in addition to the determination of the significance 204 of the fact 112 to the identity 218 of the individual 102, enables a determination of whether to add the fact 112 to the individual profile 110 or to discard the fact 112. As a third such example, an embodiment may endeavor to determine an interference confidence 802 in a selected fact 112 (e.g., an inference that the individual 102 is interested in hiking) by presenting an option set including an option that is associated with the selected fact 112 (e.g., a link to reviews of hiking gear), and other options associated with alternative facts 112 in which the individual 102 has not expressed an individual interest 810 (e.g., interests in fishing and golfing). A detection of individual interest 810 in the option associated with the selected fact 112 that exceeds the options associated with the alternative facts may enable an adjustment 808 of the inference confidence in the selected fact 112. Many such forms of supplemental information may be utilized together with the significance 204 of the fact 112 to the identity 218 of the individual 102 while determining whether or not to add the fact 112 to the individual profile 110 of the individual 102 in accordance with the techniques presented herein.

### E4. Inclusion of Fact in Individual Profile

A fourth aspect that may vary among embodiments of the techniques presented herein involves the determination of whether to add a fact 112 to the individual profile 110 of the individual 102, or to discard the fact 112 and/or exclude the fact 112 from the individual profile 110 of the individual 102.

As a first variation of this fourth aspect, for a fact 112 in storage 206 and under evaluation to determine its significance 204 to the identity 218 of the individual 102, the evaluation time 210 may be terminated if the individual 102 expressly indicates that the fact 112 has significance 204 to the identity 218 of the individual 102, and/or if the individual 102 expresses a disavowal of the fact 112 as having significance 204 to the identity 218 of the individual 102. The fact 112 may be accordingly added to the individual profile 110 and/or discarded from storage 206, even if the evaluation duration 210 from the detection time 202 has not yet elapsed. Alternatively or additionally, after a fact 112 has been added to the individual profile 110, the fact 112 may be excluded from the individual profile 110 if the individual 102 expresses a disavowal of the fact 112.

As a second variation of this fourth aspect, an embodiment may adjust the evaluation duration 210 according to a confidence of the significance 204 of the fact 112 to the identity 218 of the individual 102. For example, if a fact 112 in storage 206 is determined to have a significance 204 that remains consistently low during the evaluation period, the evaluation duration 210 may be shortened. Conversely, if a fact 112 in storage 206 is determined to have a steadily progressing significance 204 that is approaching the significance threshold 208, or has a significance 204 that is near the significance threshold 208 as the evaluation duration 210 nears completion, the evaluation duration 210 may be extended to provide additional evaluation time.

As a third variation of this fourth aspect, the individual profile 110 may include a fact limit (e.g., the presentation of no more than ten facts 112 about the individual 102). If a fact count of facts 112 in the individual profile 110 exceeds the fact limit, an embodiment may remove one or more facts having a lower significance 204 to the identity 218 of the individual 102 than other facts 112 of the individual profile 110. This variation may enable facts 112 having high significance 204 to the identity 218 of the individual 102 to replace facts 112 having lower significance 204 to the identity 218 of the individual 102, e.g., as the identity 218 of the individual 102 changes and/or as new information about the individual 102 is detected.

As a fourth variation of this fourth aspect, after adding a fact 112 to the individual profile 110 of an individual 102, an embodiment may continue to monitor the significance 204 of the fact 112 to the identity 218 of the individual 102. Upon detecting that the significance 204 of the fact 112 to the identity 218 of the individual 102 has diminished below the significance threshold 208 (e.g., determining that an interest 108 of the individual 102 has faded to the point where the interest 108 no longer has significance 204 to the identity 218 of the individual 102), the embodiment may remove the fact 112 from the individual profile 110 of the individual 102.

FIG. 9 presents an illustration of an example scenario 900 wherein the significance 204 of an activity 116 to an identity 218 of an individual 102 is monitored over time. In this example scenario 900, at a first time 904, a frequency 604 of the activity 116 performed by the individual 102 is determined (e.g., the individual 102 hikes during 60% of free weekends), and may be construed as a high significance 204 of the fact 112 that the individual 102 enjoys the activity 116 of hiking. Accordingly, the fact 112 may be added to the individual profile 110 of the individual 102. At a second time 906 after the first time 904, the frequency 604 of the activity 116 may be determined to be diminishing and therefore indicating a lower significance 204 of the fact 112 to the identity 218 of the individual 102. At a third time 908 after the second time 906, the frequency 604 of the activity 116 may be determined to have diminished to a point where the individual 102 seldom performs the activity 116, indicating a low significance 204 of the fact 112 to the identity 218 of the individual 102, and prompting an exclusion 902 of the fact 112 from the individual profile 110 of the individual 102.

As a fifth variation of this fourth aspect, techniques may be utilized to reconcile conflicting facts 112 about the individual 102. For example, an embodiment may detect that an individual 102 has expressed interest 108 in each of two rival sports teams, or in each of two opposite political parties. An embodiment may initiate monitoring the significance 204 of each fact 112 to determine which fact 112 is more representative of the identity 218 of the individual 102, and may adjust the individual profile 110 according to such determination. As one such example, an embodiment simply present to the individual a request to confirm the conflicting fact 112 that conflicts with a first fact 112, and upon receiving confirmation of the conflicting fact 112, the embodiment may exclude the first fact 112 from the individual profile 110 of the individual 102. Many such techniques may be utilized to determine which facts 112 to include in the individual profile 110 of the individual 102 in accordance with the techniques presented herein.

### F. Computing Environment

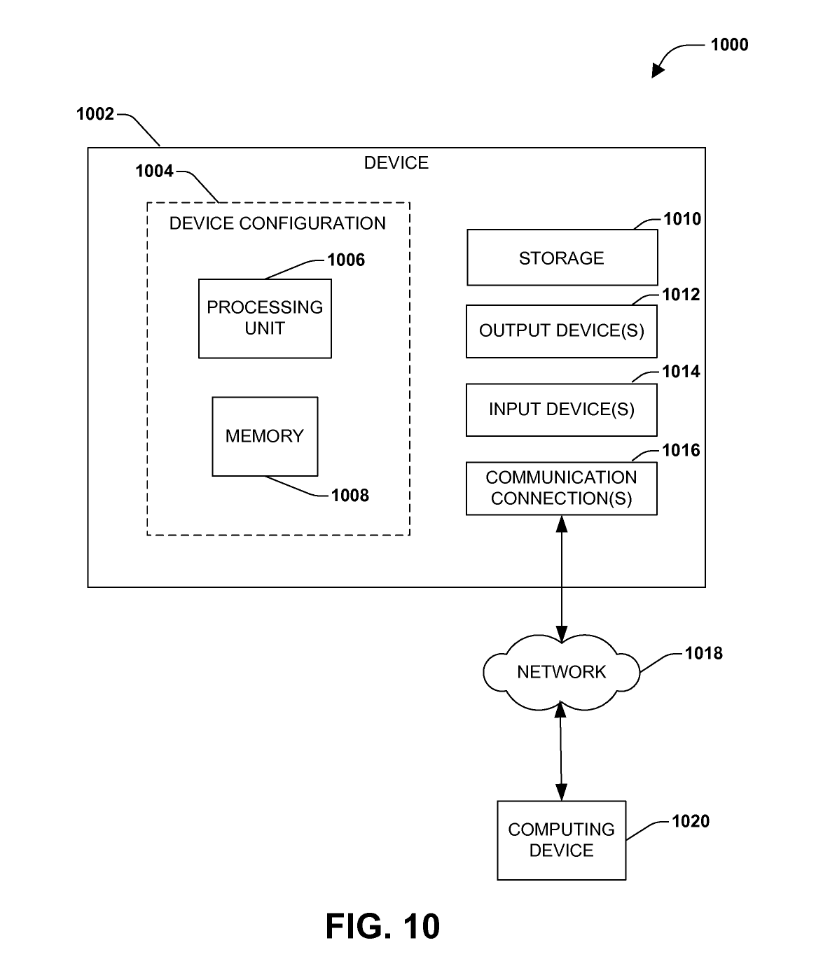

FIG. 10 and the following discussion provide a brief, general description of a suitable computing environment to implement embodiments of one or more of the provisions set forth herein. The operating environment of FIG. 10 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 10 illustrates an example of a system 1000 comprising a computing device 1002 configured to implement one or more embodiments provided herein. In one configuration, computing device 1002 includes at least one processing unit 1006 and memory 1008. Depending on the exact configuration and type of computing device, memory 1008 may be volatile (such as RAM, for example), non-volatile (such as ROM, flash memory, etc., for example) or some combination of the two. This configuration is illustrated in FIG. 10 by dashed line 1004.

In other embodiments, device 1002 may include additional features and/or functionality. For example, device 1002 may also include additional storage (e.g., removable and/or non-removable) including, but not limited to, magnetic storage, optical storage, and the like. Such additional storage is illustrated in FIG. 10 by storage 1010. In one embodiment, computer readable instructions to implement one or more embodiments provided herein may be in storage 1010. Storage 1010 may also store other computer readable instructions to implement an operating system, an application program, and the like. Computer readable instructions may be loaded in memory 1008 for execution by processing unit 1006, for example.

The term “computer readable media” as used herein includes computer-readable memory devices that exclude other forms of computer-readable media comprising communications media, such as signals. Such computer-readable memory devices may be volatile and/or nonvolatile, removable and/or non-removable, and may involve various types of physical devices storing computer readable instructions or other data. Memory 1008 and storage 1010 are examples of computer storage media. Computer-storage devices include, but are not limited to, RAM, ROM, EEPROM, flash memory or other memory technology, CD-ROM, Digital Versatile Disks (DVDs) or other optical storage, magnetic cassettes, magnetic tape, and magnetic disk storage or other magnetic storage devices.

Device 1002 may also include communication connection(s) 1016 that allows device 1002 to communicate with other devices. Communication connection(s) 1016 may include, but is not limited to, a modem, a Network Interface Card (NIC), an integrated network interface, a radio frequency transmitter/receiver, an infrared port, a USB connection, or other interfaces for connecting computing device 1002 to other computing devices. Communication connection(s) 1016 may include a wired connection or a wireless connection. Communication connection(s) 1016 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1002 may include input device(s) 1014 such as keyboard, mouse, pen, voice input device, touch input device, infrared cameras, video input devices, and/or any other input device. Output device(s) 1012 such as one or more displays, speakers, printers, and/or any other output device may also be included in device 1002. Input device(s) 1014 and output device(s) 1012 may be connected to device 1002 via a wired connection, wireless connection, or any combination thereof. In one embodiment, an input device or an output device from another computing device may be used as input device(s) 1014 or output device(s) 1012 for computing device 1002.

Components of computing device 1002 may be connected by various interconnects, such as a bus. Such interconnects may include a Peripheral Component Interconnect (PCI), such as PCI Express, a Universal Serial Bus (USB), Firewire (IEEE 1394), an optical bus structure, and the like. In another embodiment, components of computing device 1002 may be interconnected by a network. For example, memory 1008 may be comprised of multiple physical memory units located in different physical locations interconnected by a network.

Those skilled in the art will realize that storage devices utilized to store computer readable instructions may be distributed across a network. For example, a computing device 920 accessible via network 1018 may store computer readable instructions to implement one or more embodiments provided herein. Computing device 1002 may access computing device 920 and download a part or all of the computer readable instructions for execution. Alternatively, computing device 1002 may download pieces of the computer readable instructions, as needed, or some instructions may be executed at computing device 1002 and some at computing device 920.

### G. Usage of Terms

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Any aspect or design described herein as an “example” is not necessarily to be construed as advantageous over other aspects or designs. Rather, use of the word “example” is intended to present one possible aspect and/or implementation that may pertain to the techniques presented herein. Such examples are not necessary for such techniques or intended to be limiting. Various embodiments of such techniques may include such an example, alone or in combination with other features, and/or may vary and/or omit the illustrated example.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of representing an identity of an individual on a device comprising a processor and an individual profile of the individual, the method comprising:
executing, on the processor, instructions that cause the device to:
upon receiving a fact about the individual at a detection time:
determine a significance of the fact to the identity of the individual;
upon determining that the significance of the fact to the identity of the individual exceeds a significance threshold, add the fact to the individual profile; and
upon failing to add the fact to the individual profile within an evaluation duration of the detection time, discard the fact about the individual.

2. The method of claim 1, wherein determining the significance of the fact to the identity of the individual further comprises: detecting an expression by the individual of the significance of the fact to the identity of the individual.

3. The method of claim 2, wherein:
the individual specifies a fact order of the respective facts of the individual profile, wherein a first fact having an earlier fact order in the individual profile is more significant than a second fact having a later fact order in the individual profile; and
wherein determining the significance of the fact to the identity of the individual further comprises: determining the significance of the fact according to the fact order of the individual profile.

4. The method of claim 1, wherein determining the significance of the fact to the identity of the individual further comprises: among an expression set of expressions by the individual, detecting a frequency of references to the fact by the individual.

5. The method of claim 1, wherein determining the significance of the fact to the identity of the individual further comprises:
for respective activities by the individual, determine an activity conformity of the activity of the individual with the fact; and
determine an activity conformity frequency among the activities of the individual.

6. The method of claim 1, wherein determining the significance of the fact to the identity of the individual further comprises:
predicting a sensitivity of the individual to acknowledging the fact; and
upon predicting the sensitivity of the individual to acknowledging the fact that exceeds a sensitivity threshold, discarding the fact about the individual.

7. The method of claim 6, wherein predicting the sensitivity of the individual to acknowledging the fact further comprises:
determining a demographic trait of the individual; and
for an individual set comprising individuals exhibiting the demographic trait, determining a demographic sensitivity of the individuals of the individual set to acknowledging the fact;
predicting the sensitivity of the individual according to the demographic sensitivity to acknowledging the fact of the individuals of the individual set that is associated with the demographic trait of the individual.

8. The method of claim 1, wherein:
the fact comprises an inference about the individual; and
determining the significance of the fact further comprises: determining an inference confidence that the fact describes the individual.

9. The method of claim 8, wherein determining the inference confidence of the inference further comprises:
presenting a fact detail about the fact to the individual; and
detecting an individual interest of the individual in the fact detail.

10. The method of claim 8, wherein determining the inference confidence about the inference further comprises:
presenting an option set comprising the fact and at least one alternative fact; and
detecting an individual interest of the individual in the fact that exceeds the individual interest of the individual in the at least one alternative fact.

11. A server that manages an individual profile of an individual, the server comprising:
a processor; and
a memory storing instructions that, when executed on the processor, provide:
a significance evaluator that determines a significance of the fact to the identity of the individual; and
an individual profile manager that:
upon the significance evaluator determining that the significance of the fact to the identity of the individual exceeds a significance threshold, adds the fact to the individual profile; and
upon failing to add the fact to the individual profile within an evaluation duration of the detection time, discards the fact about the individual.

12. The server of claim 11, wherein the individual profile manager adjusts the evaluation duration according to a confidence of the significance of the fact to the identity of the individual.

13. The server of claim 11, wherein the individual profile manager, upon receiving a request from the individual to exclude a selected fact from the individual profile, excludes the selected fact from the individual profile.

14. The server of claim 11, wherein the individual profile manager, upon receiving from the individual a disavowal of a fact, excludes the selected fact from the individual profile.

15. The server of claim 11, wherein:
the individual profile further comprises a fact limit; and
the individual profile manager, upon determining that the individual profile comprises a fact count that exceeds the fact limit, removes at least one fact from the individual profile.

16. The server of claim 15, wherein removing the at least one fact from the individual profile further comprises:
identifying, within the individual profile, a low significance fact having a low significance to the identity of the individual among the facts of the individual profile; and
removing the low significance fact from the individual profile.

17. A memory device storing instructions that, when executed by a processor of a device storing an individual profile of an individual, manage the individual profile by:
upon receiving a fact about the individual at a detection time:
determining a significance of the fact to the identity of the individual;
upon determining that the significance of the fact to the identity of the individual exceeds a significance threshold, adding the fact to the individual profile; and
upon failing to add the fact to the individual profile within an evaluation duration of the detection time, discarding the fact about the individual.

18. The memory device of claim 17, wherein the instructions further manage the individual profile by:
after adding the fact to the individual profile, monitor the significance of the fact to the identity of the individual; and
upon detecting that the significance of the fact to the identity of the individual has diminished below the significance threshold, remove the fact from the individual profile of the individual.

19. The memory device of claim 18, wherein monitoring the fact further comprises: upon detecting a conflicting fact about the individual that conflicts with the fact, initiate monitoring the significance of the fact to the identity of the individual.

20. The memory device of claim 17, wherein the instructions further manage the individual profile by, after adding a selected fact to the individual profile and upon detecting a conflicting fact about the individual that conflicts with the selected fact:
present to the individual a request to confirm the conflicting fact; and
upon receiving confirmation of the conflicting fact, exclude the selected fact from the individual profile of the individual.
